(19) United States
(12) Patent Application Publication
(10) Pub. No.: US 2003/0056228 A1
(43) Pub. Date: Mar. 20, 2003

(54) Method and apparatus for increasing bandwidth assignment latency in a data transmission scheme which employs the aloha protocol, to thereby improve bandwidth efficiency

(76) Inventors: Mark J. Foster, Palo Alto, CA (US); Steven Wiley Rose, Haiku, HI (US)

Correspondence Address: GLENN PATENT GROUP, 3475 EDISON WAY, SUITE L, MENLO PARK, CA, 94025, US

(21) Appl. No.: 09/953,543

(22) Filed: Sep. 14, 2001

(51) Int. Cl. H04N 7/173; H04N 7/16; H04N 7/00; H04N 11/00

(52) U.S. Cl. 725/133; 725/141; 725/106; 348/552

(57) ABSTRACT

An interactive voice control application for an interactive digital television system needs greater than the typical bandwidth provided in the digital interactive television system return path. One way to obtain greater bandwidth is to make greater utilization of existing bandwidth. The invention herein provides a modified Aloha protocol that can solve the problem of maximizing bandwidth utilization without requiring changes to deployed equipment. The preferred embodiment of the invention provides a method and apparatus for increasing bandwidth assignment latency in a data transmission scheme which employs the Aloha protocol, to improve channel utilization in a multi-carrier data transmission system which thereby improves bandwidth efficiency.

### BACKGROUND OF THE INVENTION

1. Technical Field

The invention relates to data transmission. More particularly, the invention relates to a method and apparatus for increasing bandwidth assignment latency in a data transmission scheme which employs a communications protocol, such as the Aloha protocol, to improve channel utilization in a multi-carrier data transmission system which thereby improves bandwidth efficiency.

2. Description of the Prior Art

The Aloha Protocol

The Aloha protocol is a multi-access protocol from the medium access control (MAC) layer of a network architecture. Multi-access communication is communication between several sources, or nodes, across a shared communication medium, e.g. communication via an Ethernet or a satellite system. The purpose of the MAC layer is to allocate use of the shared communication medium among the competing nodes.

The protocol is used to coordinate communication between m>1 transmitting nodes. For the sake of simplicity, it is assumed that all messages are sent to one receiver and that the receiver is responsible for providing feedback. The nodes communicate by sending packets via a shared communication channel. The following assumptions are made about such system in general:

1. Slotted system. All packets have the same size, and each packet can be transmitted in one time unit, in the following referred to as a slot.

2. Poisson arrivals. Packets to be transmitted arrive at each node according to independent Poisson processes. Let λ/m be the arrival rate for each node.

3. Collision or perfect reception. A collision occurs if two or more nodes send packets in a given time slot. In this case, the receiver obtains no information about the contents or senders of the packets. If only one node transmits a packet in a slot, then it is correctly received by the receiver.

4. Retransmission of collisions. Each packet that collides with another must be retransmitted. A packet is retransmitted until it is successfully received. A node is said to be backlogged if it has a packet that must be retransmitted.

5. Buffering. Each node has a buffer containing packets to be transmitted to the receiver. These packets have been received from the data link control (DLC) layer.

The purpose of the protocol is to coordinate and make effective use of the communication channel. This is achieved by minimizing both the number of collisions and the number of slots in which no packets are sent, or alternatively, by maximizing the number of slots in which exactly one packet is sent. When a collision occurs, the transmitting nodes should not automatically retransmit their packets in the following slot because the packets would obviously collide once again. Thus, the basic idea of the Aloha protocol is to determine when backlogged and unbacklogged nodes should transmit packets. If a node is not backlogged, and its buffer is not empty, then it transmits a packet at the beginning of the next slot. Backlogged nodes retransmit in the following slots with some fixed probability Pr>0 until the packet is successfully transmitted.

With pure Aloha (see FIG. 1) in a generic application, stations are allowed access to the channel whenever they have data to transmit. Because the threat of data collision exists, each station must either monitor its transmission on the rebroadcast or await an acknowledgment from the destination station, although the stations (STBs) in the preferred implementations of the herein described system cannot monitor transmissions. By comparing the transmitted packet with the monitored transmission or by the lack of an acknowledgement, the transmitting station can determine the success of the transmitted packet. If the transmission was unsuccessful it is resent after a random amount of time to reduce the probability of re-collision.

By coordinating the transmission freedom of the individual stations, the throughput of the Aloha protocol can be improved. Assuming constant length packets, transmission time is broken into slots equivalent to the transmission time of a single packet. Stations are only allowed to transmit at slot boundaries. When packets collide, they overlap completely instead of partially. This has the effect of doubling the efficiency of the Aloha protocol and has come to be known as slotted Aloha (see FIG. 2).

Interactive Digital Cable Television Systems

In deployed interactive digital cable television systems, such as those which use a digital addressable interactive digital consumer terminal or set top box (STB), e.g. the DCT 2000 systems manufactured by Motorola, Inc. of Schaumburg, Ill. (which form the basis of the discussion herein but to which the invention is not limited), returns from several nodes are routinely combined. Two 256 k bit return path channels may end up serving as many as 4,000 subscribers. A typical configuration uses three single channel return path receiver cards in a chassis, of which one is a spare, to accommodate the return paths from eight nodes. Although there are twenty possible return channels, eighteen are typically unused.

The return path has a per channel bandwidth of 256 kbps. There are twenty channels occupying frequencies between 8 to 12 MHz. Because of the interference common in this band, there are typically no other services deployed in this range even though only two or three of the twenty channels may be used.

State of the art systems, such as the Motorola system mentioned above, use the Aloha protocol, which has a peak theoretical efficiency of 17% and a practical usable efficiency of about 10%. This theoretically reduces the 256 k bits per second to 43.5 kbps, but the actual throughput is about 20,000 bits per second. In a voice navigation system, e.g. for interactive digital television or video-on-demand services (such as provided by AgileTV of Menlo Park, Calif.), four people speaking simultaneously, e.g. at 4.8 kbps per speaker, fill this bandwidth. More speakers can be accommodated if upstream bandwidth utilization can be increased.

It would therefore be desirable to provide a system that uses more of the available spectrum, and which makes more efficient use of available bandwidth. thereby providing increased throughput, e.g. in a voice navigation system for an interactive digital television system.

### SUMMARY OF THE INVENTION

An interactive voice control application, such as that provided by AgileTV of Menlo Park, Calif., e.g. for an interactive digital television system, needs greater than the typical bandwidth provided in the present digital interactive television system return path. One way to obtain greater bandwidth is to make greater utilization of existing bandwidth. The invention herein provides a modified Aloha protocol that can solve the problem of maximizing bandwidth utilization without requiring changes to deployed equipment. The preferred embodiment of the invention provides a method and apparatus for increasing bandwidth latency in a data transmission scheme which employs a communications protocol, such as the Aloha protocol, to thereby improve bandwidth efficiency.

In the presently preferred embodiment of the invention, a modified Aloha protocol is implemented using a multichannel receive card, in which embodiment there may be up to 96 receivers per chassis. On the receive card, the entire STB return path spectrum is demodulated and decoded by individual dual core CPUs, or other appropriate devices, that are programmed as software radios. All return path information emerges on an Ethernet interface in the IP protocol.

With the herein disclosed modified Aloha protocol, the relatively nondeterministic nature of the timing of the operation of state of the art systems is overcome, and the bandwidth efficiency allows the use of significantly more of each 256 kbps channel. In the preferred embodiment, one of the remaining available channels is used for a shared request channel.

An important aspect of the herein disclosed modified Aloha protocol is to allow individual transmitters to own a channel for a complete transmission sequence. The usable data channel bandwidth approaches the channel capacity as it becomes significantly longer than the average latency. In such an approach, upstream collisions are dramatically reduced. Upstream transmissions on each channel are time multiplexed, and the period of each upstream transmission is completely variable, depending on the needs of each set top box and the total amount of traffic at that time.

### BRIEF DESCRIPTION OF THE DRAWINGS

FIG. 1a is a timing diagram showing operation of the pure Aloha protocol;

FIG. 1b is a timing diagram showing operation of the slotted Aloha protocol;

FIG. 2 is a block schematic diagram showing the modified Aloha protocol from a single STB perspective according to the invention;

FIG. 3 is a block schematic diagram of a receive card according to the invention;

FIG. 4 is a block schematic diagram showing the herein described modified Aloha protocol including a novel ECC scheme according to the invention;

FIG. 5 is a block schematic diagram which shows the utilization of three channels through two instances of bandwidth assignment using the herein disclosed modified Aloha protocol; and

FIG. 6 is a block schematic diagram showing single channel, time domain multiplexing via the herein disclosed modified Aloha protocol.

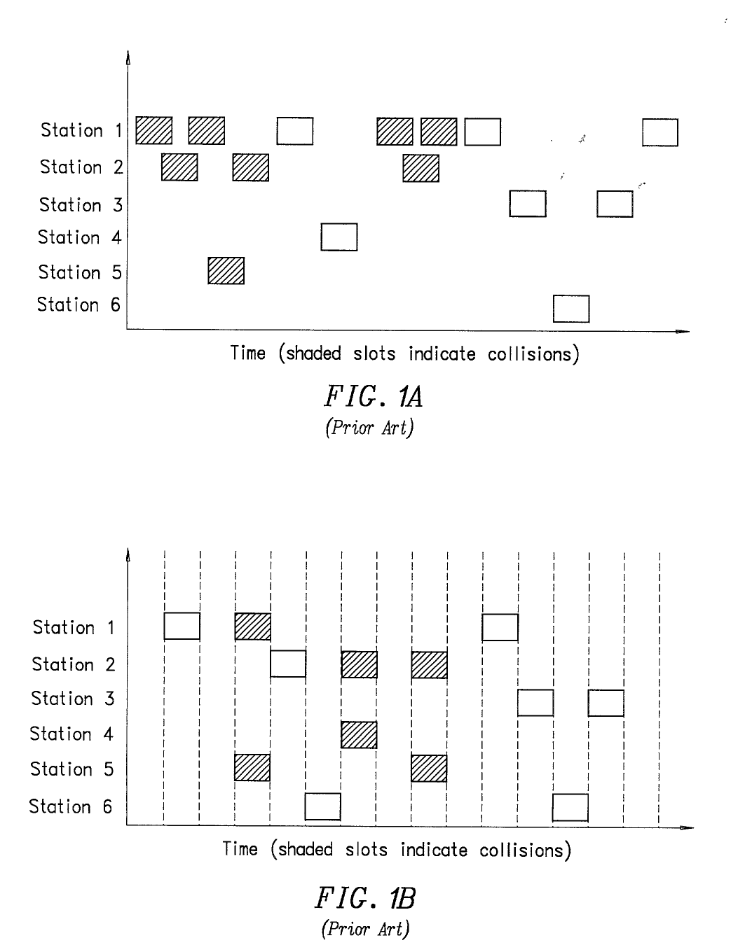

### DETAILED DESCRIPTION OF THE INVENTION

An interactive voice control application, such as that provided by AgileTV of Menlo Park, Calif., e.g. for an interactive digital television system, needs greater than the typical bandwidth provided in the digital interactive television system return path. One way to obtain greater bandwidth is to make greater utilization of existing bandwidth. The invention herein provides a modified Aloha protocol that solves the problem of maximizing bandwidth utilization without requiring changes to deployed equipment. The preferred embodiment of the invention provides a method and apparatus for increasing bandwidth assignment latency in a data transmission scheme which employs the Aloha protocol to improve bandwidth efficiency. While the preferred embodiment is concerned with a voice control or navigation system for an interactive digital television system, those skilled in the art will appreciate that the invention is readily applied to any other multi-carrier communications system, where maximization of bandwidth utilization is of importance.

For purposes of the discussion herein, it is assumed that those skilled in the art have a familiarity with the following cable television concepts:

59. Set top box (STB) operation;

60. Hybrid Fiber Coax architecture, e.g. nodes of 500-2,000 homes served by a single fiber pair originating at a central point, asymmetrical upstream bandwidth; and

61. Return path issues, including protocols, bandwidth, and combined returns.

As used herein, upstream and return path refer to the same concept, i.e. where the signal is transmitted from the STB to the control point, which may be referred to as a hub or as a head end.

For purposes of the discussion herein, two sources of latency are mentioned:

59.The latency of the downstream out-of-band (OOB) transmitter, which is shared for multiple purposes; and

60.The latency of the STB in responding to a transmit command, when it is given the opportunity to send data upstream.

As used herein, cyclic redundancy check (CRC) is a technique which allows a receiver to determine with great certainty whether the information it has received has been corrupted by the transmission process, or has retained its integrity.

As used herein, error correction code (ECC) is a technique which allows a receiver to reconstruct many cases of corrupted data.

In the exemplary embodiment of the invention, ATM-like cells of 62 octets, i.e. 8-bit bytes, each are used at the finest granularity of packetization for data transmission. The OOB transmitter (and other implementation specifics disclosed herein) do not limit the application of the invention, e.g. the downstream transmitter could be an in-band transmitter.

Although the invention described herein is discussed in connection with an STB, such as the Motorola DCT-2000 system, its techniques may be applied in any multi-carrier system, using any medium of communications. It is preferably applied in systems currently using a communications protocol, such as the Aloha protocol. Although the modified Aloha protocol is designed to work around parameters, primarily latencies, over which there no control in the current instance, it works even more effectively in a system specifically designed to accommodate it.

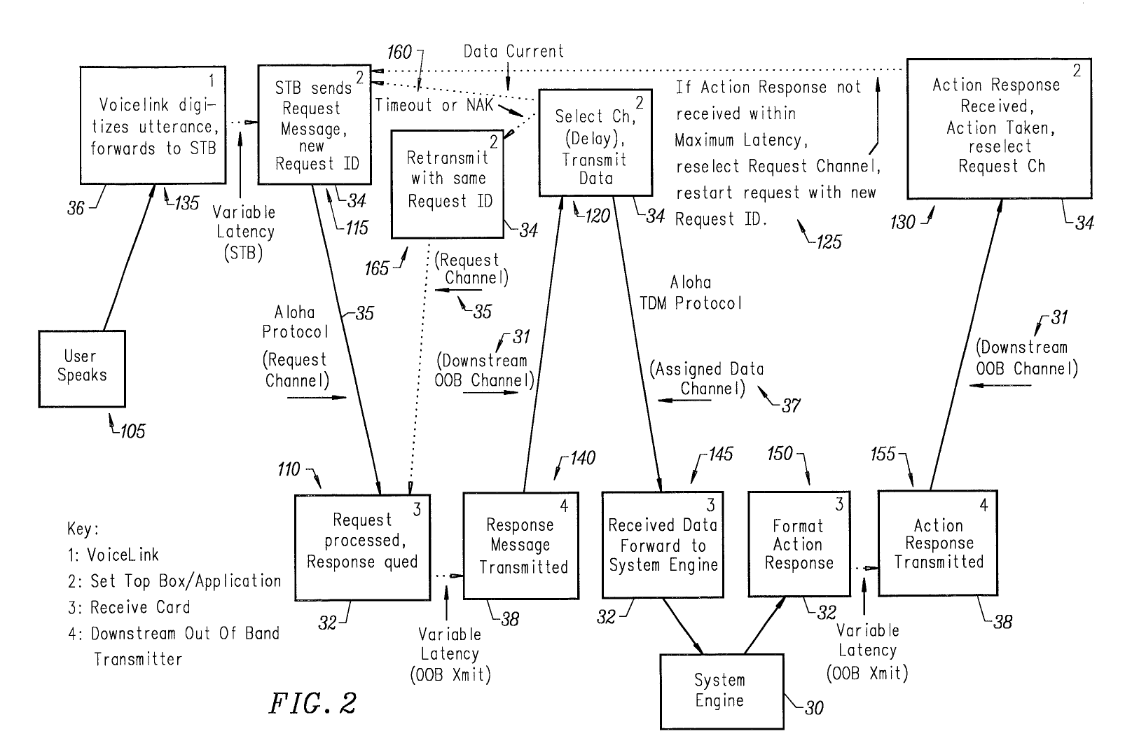

FIG. 2 is a block schematic diagram showing the modified Aloha protocol from a single STB perspective according to the invention. On FIG. 2, two-digit numeric designators generally indicate structure and three-digit numeric designators generally indicate steps.

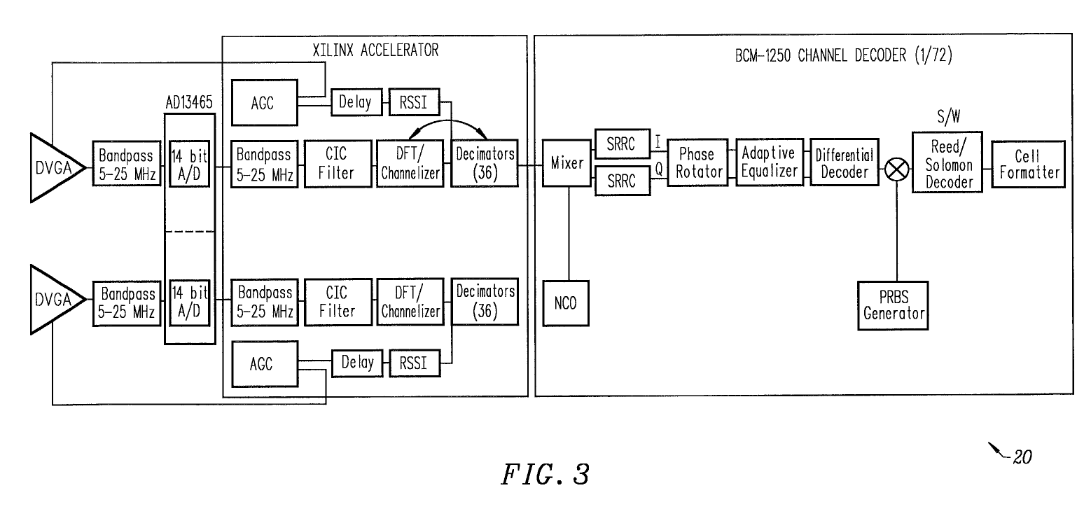

In the presently preferred embodiment of the invention, a modified Aloha protocol is implemented using a multichannel receive card 32 (See FIG. 3). In the presently preferred embodiment of the invention, there may be up to 96 receiver inputs per chassis [12 cards*8 inputs/card=96 inpouts]. On the exemplary receive card, the entire STB return path spectrum is demodulated and decoded by individual dual core CPUs, or other appropriate devices, that are programmed as software radios. A software radio uses a DSP or microprocessor to sample the tuned and filtered analog bandwidth of interest, then uses mathematical techniques to isolate and demodulate individual carriers located in that spectrum. It may further process the demodulated data, including combining the data from individual carriers into a single packetized data stream, segregating and recombining data from different carriers into multiple data streams, or presenting data representing an analog signal to a digital to analog converter. See for example, Software Radio Architecture Object Oriented Approaches to Wireless Systems Engineering (John Wiley & Sons), (2000). All return path information emerges on an Ethernet interface in the IP protocol.

With the herein disclosed modified Aloha protocol, the relatively nondeterministic nature of the operation of state of the art systems is overcome, and the bandwidth efficiency allows the use of significantly more of each 256 kbps channel. In the preferred embodiment, one of the remaining available channels is used for a shared request channel (discussed below).

An important aspect of the herein disclosed modified Aloha protocol is to allow individual transmitters to own a channel for a complete transmission sequence. Another important aspect of the herein disclosed modified Aloha protocol is to allow each upstream data transmission time allocation to be as long as possible. The invention minimizes the hand-off between STBs by concatentating all calls from a single STB into a continuous transmission. The usable data channel bandwidth approaches the channel capacity as it becomes significantly longer than the average latency. In such an approach, upstream collisions are significantly reduced. Upstream transmissions on each channel are time multiplexed, and the period of each upstream transmission is completely variable, depending on the needs of each set top box and the total amount of traffic at that time.

Normal Operation (no Data Corruption Encountered)

The user states a request 105, e.g. “tune to channel five.” The user's utterance is captured and encoded by the voice link 36 (step 135). The voice link notifies the application on the STB, which generates a request message 115. The receive card processes the request message 110 and sends a response message 140 via the OOB transmitter telling the STB where, e.g. which channel, and when, e.g. relative delay, to send its data 120. The relative delay is calculated by adding the time for the transmissions and worst case transmission latencies of all STBs preceding this one in the response message. It includes a settling time for the STB upstream transmitter if it has been commanded to tune to a different channel, and it may also include any fixed allowance for the physical location of each STB. It is a relative delay, e.g. timed from the moment of receipt, rather than an absolute clock time to account for the variable latency of the response message transmitter.

The STB sends the voice link data in data message format 37 at the specified time. The receive card sends the data to the system engine 30 (step 145), which recognizes the user's request and formulates an appropriate action 150. The action message is transmitted to the STB via the receive card and the OOB transmitter 155. The STB receives the action message and implements the actions indicated 130, which may be local to the STB, e.g. change channel, done in conjunction with a central applications server, e.g. “show me the weather on Maui,” or done in conjunction with other equipment, e.g. “call the office.”

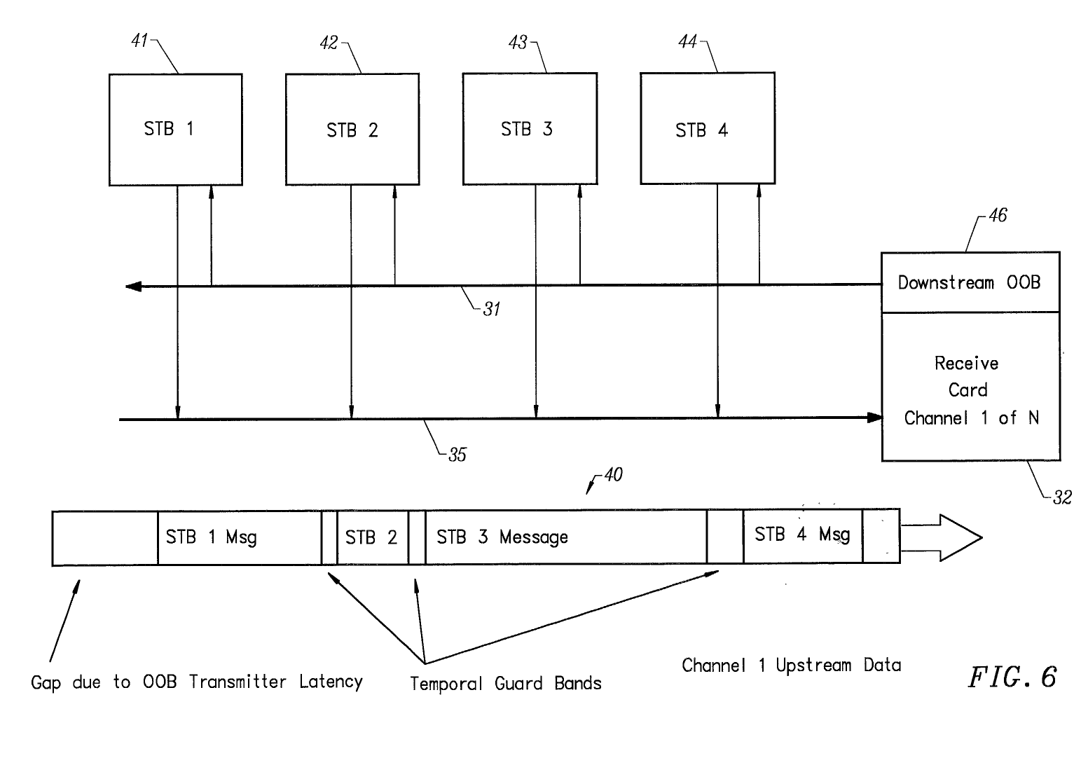

By this means, the modified Aloha protocol allows as good a response capability as the STB system architecture permits, under all circumstances. Further enhancements in performance are possible by controlling the timing of the downstream information deterministically. This would allow one, for example, to run the shared request channel in slotted Aloha mode, and to eliminate the guard band latency otherwise necessary to account for system architecture delays (see FIG. 6 with regard to guard bands). Additional timing and bandwidth benefits would derive from tighter STB communication controls. For example, having deterministic timing on the STB downstream transmitter, the worst case transmission latency in the downstream time slot allocation calculation can be replaced with a known, fixed value. The benefit is the sum of the differences between the worst case and fixed delays in each allocation, and can make it practical to increase the number of slots in each allocation. If the timing is accurate enough, offsets of transmission times may even be applied to accommodate the physical location of the STB in the cable plant. In a conventional cable architecture, this could account for a few percent increase in efficiency. For a satellite application, the resulting gains in efficiency would be much greater.

The Shared Request Channel and the Request Message

When an STB 34 has data available 115, it uses the shared request channel 35 to send a request message to the receive card, identifying itself and stating the amount of data it has to send. The request message also has a message type field to allow for future system expansion for other applications. For example, the request channel could be used for very small amounts of data, such as remote control button push information. In this case, the message type field would signal that no further upstream allocation is required, and would allow routing the data. Another use would be to signal the availability of other forms of data of lower priority than speech, such as STB or voice link management data. Other examples could include the data from local forms fill-in, sending block data to the head-end, etc. It would also allow integration with existing applications of all sorts. Details of some of the various possible message formats which could be used in the invention are provided below in Tables 1-5.

Each new request message from an STB is sequentially numbered, so that a duplicated request can be identified and ignored. This is mandated by the shared request channel because it is running a standard Aloha protocol, and a retransmission may be required. Because there is a variable latency in the downstream channel 31 which is not under the system's control, and which typically may last from a few milliseconds to three seconds or so, the STB preferably retransmits its request periodically, e.g. every 500 milliseconds or so, to insure that there has not been a collision, until a response message or acknowledgement is received. A random interval, typically an integer multiple of the request message duration, is added to the period before retransmission occurs to avoided repeated collisions.

The request message may also contain a timestamp so that received requests may be prioritized. The use of the timestamp depends on the availability of a system-wide clock because it only has meaning relative to the timestamps of requests from other STBs.

The next to last field is a CRC, which is used to verify the integrity of the message. If the CRC field does not match the calculated CRC, the request message is ignored, i.e. it is retransmitted automatically. If the STB identification field appears valid, but the CRC does not match, a NAK message may be sent to the STB 160 so that it retransmits right away 165, rather than waiting for its timeout period. If a NAK is sent to an invalid address, or to an STB that is not waiting for a response, it is ignored.

The shared request channel operates using Aloha protocol, which becomes significantly less efficient as more and more users share the same bandwidth. The receive card monitors all channels simultaneously, and has up to forty-eight channels available. The receive card periodically examines how the channels may be reassigned to minimize system latency, and allocates as many physical RF channels as necessary to serve as the logical shared request channel. It then distributes the use of the request channels to equalize traffic. One channel always remains the default shared request channel 35. If an STB becomes confused and is not getting any response or acknowledgement messages, it falls back to the default shared request channel. In this manner, the receive card can dynamically adjust bandwidth utilization as circumstances change, or as new applications are deployed that alter the bandwidth profile.

ECC

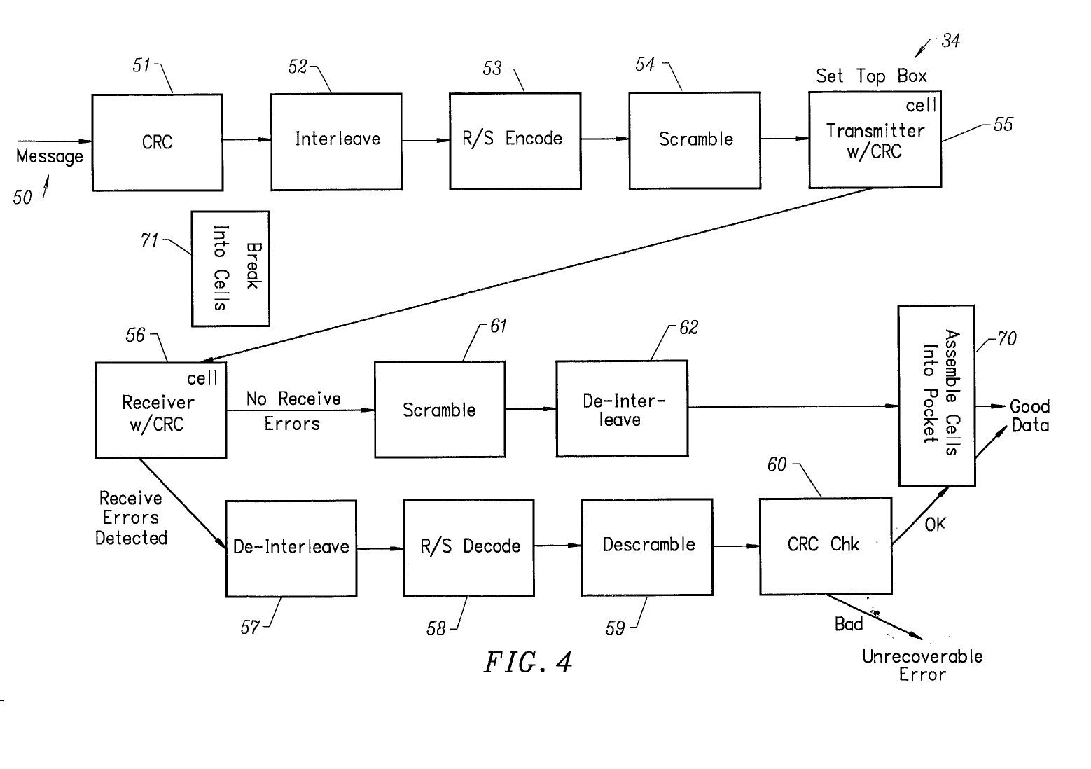

FIG. 4 is a block schematic diagram showing the herein described modified Aloha protocol including a novel ECC scheme. The last field in a message 50 is the ECC, which comprises a group of bits that when applied to the remainder of the data using the Reed/Solomon algorithm can correct many errors that may have been introduced by interference in the transmission pathway. Each modified Aloha protocol message has a Reed/Solomon error correcting code (ECC), i.e. additional data that allows one or more bit errors to be corrected. Reed-Solomon codes are block-based error correcting codes with a wide range of applications in digital communications and storage. The Reed-Solomon encoder 53 takes a block of digital data and adds redundant bits. Errors occur during transmission or storage for a number of reasons, for example noise or interference. The Reed-Solomon decoder 58 processes each block and attempts to correct errors and recover the original data. The number and type of errors that can be corrected depends on the characteristics of the Reed-Solomon code.

The use of Reed/Solomon codes in the herein disclosed invention permits many data errors caused by bursty RF interference typical of a cable plant to be corrected, rather than forcing a retransmission of the message. The additional overhead to apply the ECC data is necessary only if an error is noted in the incoming data by the cell by cell and submessage by submessage CRC checking. A message is transmitted as one to many cells, and may contain submessages with their own CRC. Avoiding latency is very important in the herein disclosed system, and any retransmission is a significant source of latency. FIG. 4 illustrates the possible pathways of a message through the system. First, a cyclic redundancy check (CRC) value is calculated 51 for the message, or in the case of a multiple destination response message, for the message header and each submessage. This CRC value may be used at the end of the reception process, after all fixes have been applied, to determine if the message or submessage is intact. The message is broken into cells 71.

Optionally, the resulting data are interleaved 52. The order of blocks of data is mixed up in a reversible manner, where a block is a byte or larger. The purpose of this step is to make sure that a single instance of interference affects small portions of data throughout a message, rather than contiguous bits. Scattered small errors are more readily fixed than one long error.

The data are then processed by the Reed/Solomon encoder 53, which calculates an error correcting code (ECC) value for the message. This value may be applied at the receiving end if transmission errors are detected to attempt to fix the errors.

Next, the message and appended CRC is passes through a scrambler 54. The purpose of the scrambler is to eliminate long runs of 1s or 0s, and to guarantee an equal number of ones and zeros in the resulting bit stream. This avoids the DC offset problem in the resulting data stream as it passes through various pieces of equipment. The scrambling uses a reversible XOR based algorithm.

The message may then be processed by a cell transmitter 55, which partitions the resulting data into a series of cells, typically 62 octet (8 bit byte) cells consisting of a header, with its own CRC information, and a data payload. The portion of the 62 bytes which comprises the payload may vary.

At the other end, each cell is received 56, and the CRC of the payload is calculated and compared to the value transmitted in the header. Successive payloads are reassembled into the original (interleaved and scrambled) message. If no CRC errors are detected in transmission, then the message may be descrambled 61, deinterleaved 62, and the cells are assembled (the upper pathway of the receive portion of FIG. 4) into packets 70. If CRC errors are detected in transmission, then the message is deinterleaved 57, the Reed/Solomon ECC applied 58, and descrambled. 59. The overall message may then be checked for integrity using its CRC 60. In the case of submessages, each one may be individually checked for integrity using its CRC, and only those in error need be discarded and eventually retransmitted. If no CRC errors are detected, the cells are assembled into packets 70.

The Response Message

The receive card responds with a downstream message 110, 140 to acknowledge the receipt of one or more request messages, and to inform one or more corresponding STBs how and when to transmit their information. There are two resources available to the scheduler: Channels currently assigned for upstream data, as opposed to request channels, and time intervals within each channel. Priority is assigned to each request depending on the order in which it is received, by its time stamp, if time stamps are in use. Response message assignments are first distributed by channel because all channels can operate concurrently, thereby minimizing latency. When the number of requests exceeds the number of channels, multiple response assignments may be assigned to each channel by using time interval assignment on that channel.

A channel may be known to be unavailable at a given moment if it is still receiving data from a previous allocation. The scheduler must track this parameter for each channel, which is equal to the delay period for the last transmission scheduled on that channel plus the time for the last transmission to occur. The latency of the downstream OOB transmitter must also be added. Rather than using the worst case value for this latency, it may be determined for each transmission by tracking when the first transmission allocated in the response message occurs, and subtracting the best case (minimum) delay of the STB.

Each cycle of the scheduler may occur as rapidly as possible, or an arbitrary collection interval may be introduced during which requests accumulate.

Response assignments are generally distributed on a round robin basis to minimize overall latency: If there are three available data channels, request 1 is assigned to channel 1, request 2 to channel 2, 3 to 3, 4 to 1, 5 to 2, 6 to 3, 7 to 1, etc. However, because the amount of data to be transmitted is known in each case, and occurs at a constant rate, the duration of each upstream data transmission is known. This information may be used to alter the sequence of time interval channel assignments to minimize overall latency. For example, if request 1 takes twice as long to transmit as request 2, then request 4 (which would otherwise have been assigned to channel 1 following request 1) may be assigned to channel 2. In all cases, the operation of the assignment algorithm shall act in a manner that minimizes overall latency.

When multiple time interval assignments are made on a single channel, three factors must by considered in determining the time allocated to each requestor for its upstream data transmission. First is the time for the data transmission itself. As mentioned above, this is a known period because the number of bytes to be transmitted is known as, the rate of transmission. The second factor is the worst case latency of the STB in reacting to the response message (for the first STB), plus any latency encountered in initiating a response after the delay period has elapsed (second and later STBs). These are fixed parameters supplied by the STB manufacturer, however in a system with a mix of STBs, a database could be used to provide the specific number for the STB in question. The third parameter, which in most cases could be disregarded, is the additional delay caused by the physical location of the box in the cable system. This is also a STB specific number determined by the location where it is installed, which would be database derived. The response message contains fields indicating the STB ID, the upstream channel assignment to be used for the data, the amount of information to be transmitted, and a delay period before transmitting. In this manner, each STB can transmit all of its data as a block, without worrying about contention. The concatenation of multiple upstream transmissions in periods of high demand reduces the impact of system latency in wasting upstream bandwidth, and avoids the collisions which otherwise reduce the system to a fraction of its potential bandwidth.

The likelihood of corruption of the response message is low, and would generally be due to a burst of interference that might only corrupt a small portion of the message. Therefore, the header and each STB message has its own CRC, so that any portion of the message arriving intact may be used.

The Acknowledge Message

If the processing of the response message may take a significant amount of time, as compared to the frequency of retransmission, then an acknowledge message is available. It may also be used for a NAK message if circumstances warrant it. For example, if the retransmit frequency is 500 milliseconds, and enough of a packet is received to identify the sender but the data are garbled, a NAK may be sent so that the packet is retransmitted immediately. If an STB receives a NAK message, and it has not sent a request, it ignores the message. If it has sent a request, it immediately resends the request with the same request ID.

A broadcast NAK may also be employed at the end of a response message or an acknowledge message, if the receiver has detected a known collision. If an STB has transmitted a request message, but not received a response or acknowledge message, it assumes that it was involved in the collision and after a short random delay it retransmits its response. If the response is redundant, it is ignored. All other STBs ignore the broadcast NAK. By this means, feedback may be provided to the STBs which otherwise have no means of detecting a collision. A retransmission can occur right away for collided requests, minimizing the latency, e.g. the 500 ms waiting period, that would otherwise be employees in an absence of collision information.

Multiple Simultaneous Requests

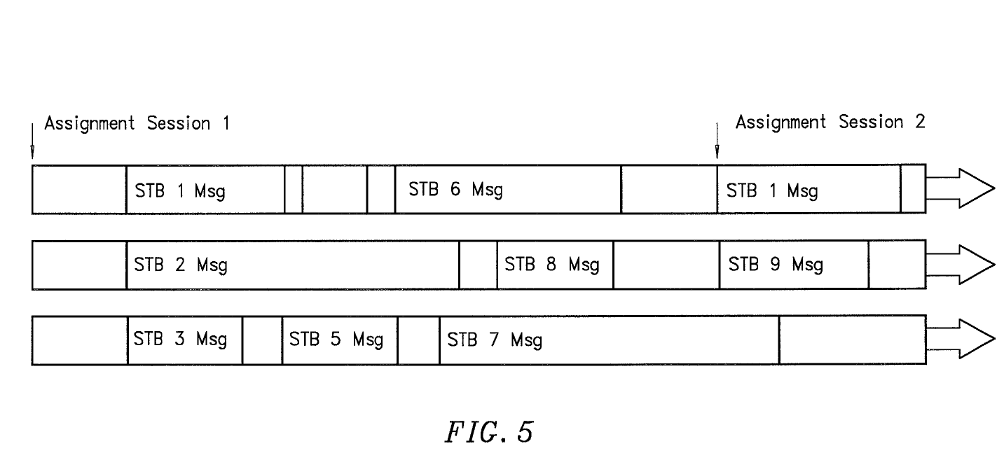

FIG. 6 is a block schematic diagram showing single channel, time domain multiplexing via the herein disclosed modified Aloha protocol. In FIG. 5, it may be seen that the temporal guard bands in the channel 1 upstream data are of variable length. The guard band allowance is calculated using worst case considerations for the STB upstream transmit latency, which by definition introduces variability. With tight control over STB latency, as mentioned above, the guard bands may be reduced to a duration approaching zero, greatly increasing channel utilization. For the same reason overall efficiency may be significantly increased by controlling and minimizing OOB transmitter latency. OOB transmitter latency affects all channels, and has a predominant influence over efficiency. Successive or simultaneous requests from different STBs may be assigned to different upstream channels, so that STB responses may be overlapped using frequency division multiplexing (FDM). Even in this case, the modified Aloha protocol increases system efficiency by addressing multiple STBs with each response message. When it becomes necessary to reuse a frequency, the modified Aloha protocol is used to increase the time domain multiplexing (TDM) efficiency of utilization of that channel.

When there is more than one pending request, a single response message 40 may contain channel assignments for multiple STBs 41-44. When the number of pending requests is greater than the number of channels, sequential responses from different STBs on the same channel may be scheduled with a single message because the duration of each transmission is known and the worst case latency for STB response is known. The second box to respond on the same channel is instructed to wait for a period that equals the sum of the transmission time for the first message, plus the worst case latency for upstream transmission, which is the sum of the response latency of the box and any system delay due to the physical location of the subscriber on the system. The location delay may be a system worst case, a node worst case, or it may be measured and maintained in a local database on an individual subscriber basis.

Many messages are no larger than the data payload of a single cell. In this case, the validation of the CRC of the cell verifies the integrity of its contents, and no further CRC or ECC checks need be applied. By the same token, if a message spans multiple cells, and each has a valid CRC, the message may be assumed to be intact without further checking. Latency is a key issue addressed in a real time system such as that described herein, and when there is a problem with any cells used to transport a message, the system applies several further steps to recover the information to avoid a retransmission and its corresponding latency. Even when a retransmission is required, it is important to tighten each loop so as little time as possible is wasted.

The response message 50 is structured with a CRC 51 for its header, and a CRC for each submessage targeted to a different STB. It is transmitted by the out of band (OOB) downstream transmitter 46 (FIGS. 2 and 4), whose broadcasts have a very low probability of corruption. An individual STB waiting for a response message may proceed with confidence if its portion of the response message is intact, as indicated by its CRC 60. If the CRC indicates damage, then the ECC field at the end of the message is applied to the entire buffered message and the CRC test is reapplied to the relevant submessage. If it is now found to be intact, it may be used. If it is still damaged, then the process loops back and initiates a new request message using a new request ID because the original transmit window is likely to have been missed.

By the same token, if the STB sees its ID in the header, but fails to find its response submessage, it must loop back and generate an new request message with a new request ID.

The end of message field on the response message helps to maintain synchronization if the header, which implicitly denotes the length of the message, is corrupted.

When the receive card receives a request message 110 (FIG. 2), it examines the request ID. If the request ID is unique for that STB, the request message is processed. If the request ID is the same as an earlier request ID, and the scheduled arrival time for the corresponding data has not yet passed, as determined by the response of other STBs in the same message or by maximum latency, the request message is ignored as a timeout generated duplicate, which is generated by the STB to account for collisions. If it was generated by a NAK to the STB, the original corrupted message is purged and the request ID is once again seen as unique. If the arrival time for the data passes with no data received, the request ID is reprocessed because the STB did not receive the original message, i.e. the entire message may have been corrupted beyond the means of the ECC to repair.

If the STB receives a second response message for the same request ID, and the channel and delay are identical to the original message, it is ignored. If they are different, the data transmission is repeated. If for any reason the receive card receives two sets of data identified by the same request ID and STB ID, the second set is ignored.

The number of STBs that may be addressed in a single message is logically limited when the sum of the worst case response times, less the sum of the typical case response times, exceeds the typical case latency for the downstream transmission (although there is no physical limit). The first STB is always given a wait of 0 units plus an allowance for the settling time of the retuned transmitter. The wait period for subsequent boxes is always a relative wait, rather than an absolute transmission time, to accommodate the variable downstream message latency. The units for the waiting period may be in packet times, if the size of packets is fixed, or in seconds, or in system clock ticks (if they are consistent from STB to STB. The choice depends on which is most readily implemented in the target STB.

Having received its response message 120, the STB tunes to the designated channel, waits for the specified delay to elapse, then transmits its negotiated amount of data. It then retunes to the request channel. A timer is started which represents the maximum latency that might be encountered, which is primarily the latency of the downstream OOB transmitter 38, and the STB waits for its action message. If no action message is received before the timer elapses 125, the STB sends a new request message 115 with a new request ID, thereby restarting the process. If an action message is received 130, the STB takes the indicated action. Tables 1-5 below show modified Aloha protocol message types.

TABLE 1
Request Message (from STB)
Request Message (from STB)

Message Type
STB ID
Timestamp
Request ID (sequence number)
Size of Data to be Transmitted
CRC (Cyclic Redundancy Check)
ECC (Error Correcting Code)

TABLE 2
Response Message (to STBs)
Response Message (to STBs)

Message Type
Number of STBs addressed in this message
STB Address List . . . (this field occurs once per STB addressed in this
message)
CRC
>>>> Repeated as Required: <<<<<
STB ID
Request ID
Delay (always 0 for STB 1)
Size of Data to be Transmitted
Data Channel Assignment
CRC
>>>>> (repeats for number of STBs) <<<<<
End of Message Marker
ECC

TABLE 3
Acknowledge Message (to STBs) (optional)
Acknowledge Message (to STBs) (optional)

Message Type
Number of STBs addressed in this message
>>>> Repeated as Required: <<<<<
STB ID
Ack/Nak
>>>>> (repeats for number of STBs) <<<<<
CRC
ECC

TABLE 4
Data Message (from STB)
Data Message (from STB)

Message Type
STB ID
Request ID
Data Size
Data
CRC
ECC

TABLE 5
Action Message (to STB)
Action Message (to STB)

Message Type
STB ID
Action
CRC
ECC

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An interactive voice control application for an interactive digital television system, comprising:
a receive module;
at least one set top box;
means for implementing a data transmission scheme between said at least one set top box and said receive module; and
means for increasing bandwidth latency in said data transmission scheme to improve interactive digital television.

2. The interactive voice control application of claim 1, said receive module comprising:
a multichannel receive card comprising a plurality of channels for communication with at least one set top box, wherein at least one of said channels is a shared request channel.

3. The interactive voice control application of claim 2, wherein said at least one set top box uses said shared request channel to send a request message to said receive card when said at least one set top box has data available, said at least one set top box identifying itself and stating an amount of data that it has to send.

4. The interactive voice control application of claim 1, said means for increasing bandwidth latency comprising:
means for maximizing sequential transmit time for each transmitter.

5. The interactive voice control application of claim 4, wherein upstream transmissions on each channel are time multiplexed, and the period of each upstream transmission is completely variable, depending on the needs of each of said at least one set top box and a total amount of traffic at that time.

6. The interactive voice control application of claim 1, further comprising:
a voice link for capturing a user's utterance.

7. The interactive voice control application of claim 6,wherein said voice link notifies an application on said at least one set top box, which generates a request message;
said receive module processing said request message from said at least one set top box and sending a response message via an out of band transmitter telling said at least one set top box where to send its data.

8. The interactive voice control application of claim 7, wherein said at least one set top box sends voice link data in data message at a specified time.

9. The interactive voice control application of claim 8, wherein said receive module sends said voice link data to a system engine, wherein said system engine recognizes a user's request and formulates an appropriate action.

10. The interactive voice control application of claim 9, wherein an action message is transmitted to said at least one set top box via said receive module and said out of band transmitter.

11. The interactive voice control application of claim 10, wherein said at least one set top box receives said action message and implements actions indicated therein, which actions may be any of local to said at least one set top box, performed in conjunction with a system engine, or performed in conjunction with other equipment.

12. The interactive voice control application of claim 3, said request message comprising:
a CRC checking scheme.

13. The interactive voice control application of claim 12, said request message comprising:
an error correcting code (ECC) that permits data errors to be corrected, rather than forcing a retransmission of said message;
wherein said ECC is decoded only if an error is noted in incoming data by said CRC checking scheme.

14. The interactive voice control application of claim 1, wherein said receive module comprises:
means for dynamically adjusting bandwidth utilization as circumstances change, or as new applications are deployed that alter a bandwidth profile.

15. The interactive voice control application of claim 3, wherein said receive module responds with a downstream response message to acknowledge receipt of one or more request messages, and informs a corresponding one or more set top box how and when to transmit information.

16. The interactive voice control application of claim 15, wherein said receive module response message contains fields indicating any of set top box ID, upstream channel assignment to be used for data, amount of information to be transmitted, and a delay period before transmitting.

17. The interactive voice control application of claim 1, wherein concatenation of multiple upstream transmissions in periods of high demand reduces the impact of system latency in wasting upstream bandwidth, and avoids collisions.

18. The interactive voice control application of claim 3, further comprising:
an acknowledge message.

19. The interactive voice control application of claim 1, wherein successive or simultaneous requests from different set top boxes may be assigned to different upstream channels, wherein set top box responses may be overlapped using frequency division multiplexing.

20. The interactive voice control application of claim 15, further comprising:
means for addressing multiple set top boxes with each response message.

21. The interactive voice control application of claim 15, wherein a single response message may contain channel assignments for multiple set top boxes when there is more than one pending request.

22. The interactive voice control application of claim 15, wherein sequential responses from different set top boxes on a same channel may be scheduled with a single message when a number of pending requests is greater than a number of channels.

23. The interactive voice control application of claim 22, wherein a second set top box to respond on a same channel is instructed to wait for a period that equals a sum of a transmission time for a first message, plus a worst case latency for upstream transmission, which is a sum of a response latency of said second set top box and any system delay due to a physical location of a subscriber;
wherein location delay may optionally be any of a system worst case, a node worst case, or it may be measured and maintained in a local database on an individual subscriber basis;
and wherein units for said wait period may optionally be in any of packet times if a size of packets is fixed, in seconds, or in system clock ticks.

24. The interactive voice control application of claim 15, wherein having received a response message, said at least one set top box tunes to a designated channel, waits for a specified delay to elapse;
wherein said at least one set top box then transmits its negotiated amount of data;
wherein said at least one set top box then retunes to said request channel;
wherein a timer is started which represents maximum latency that might be encountered;
wherein said at least one set top box waits for its action message;
wherein if no action message is received before said timer elapses, said at least one set top box sends a new request message with a new request ID; and
wherein if an action message is received, said at least one set top box takes an indicated action.

25. An interactive voice control application for an interactive digital television system, comprising:
a receive module, said receive module comprising a multichannel receive card comprising a plurality of channels for communication with at least one set top box, wherein at least one of said channels is a shared request channel;
at least one set top box; and
means for implementing a data transmission scheme between said at least one set top box and said receive module.

26. The interactive voice control application of claim 24, further comprising:
means for increasing bandwidth latency in said data transmission scheme to improve interactive digital television.

27. An interactive voice control method for an interactive digital television system, comprising the steps of:
providing a receive module;
providing at least one set top box;
implementing a data transmission scheme between said at least one set top box and said receive module; and
increasing bandwidth latency in said data transmission scheme to improve interactive digital television.

28. The method of claim 27, further comprising the step of:
providing a multichannel receive card comprising a plurality of channels for communication with at least one set top box, wherein at least one of said channels is a shared request channel.

29. The method of claim 28, wherein said at least one set top box uses said shared request channel to send a request message to said receive card when said at least one set top box has data available, said at least one set top box identifying itself and stating an amount of data that it has to send.

30. The method of claim 27, wherein increasing bandwidth latency comprises the step of:
maximizing sequential transmit time for each transmitter.

31. The method of claim 30, wherein upstream transmissions on each channel are time multiplexed, and a period of each upstream transmission is completely variable, depending on the needs of each of said at least one set top box and a total amount of traffic at that time.

32. The method of claim 27, further comprising the step of:
providing a voice link for capturing a user's utterance.

33. The method of claim 32, wherein said voice link notifies an application on said at least one set top box, which generates a request message;
said receive module processing said request message from said at least one set top box and sending a response message via an out of band transmitter telling said at least one set top box where to send its data.

34. The method of claim 33, wherein said at least one set top box sends voice link data in data message at a specified time.

35. The method of claim 34, wherein said receive module sends said voice link data to a system engine, wherein said system engine recognizes a user's request and formulates an appropriate action.

36. The method of claim 35, wherein an action message is transmitted to said at least one set top box via said receive module and said out of band transmitter.

37. The method of claim 36, wherein said at least one set top box receives sa id action message and implements actions indicated therein, which actions may be any of local to said at least one set top box, performed in conjunction with a system engine channel, or performed in conjunction with other equipment.

38. The method of claim 29, said request message comprising:
a CRC checking scheme.

39. The method of claim 38, said request message comprising:
an error correcting code (ECC) that permits data errors to be corrected, rather than forcing a retransmission of said message;
wherein said ECC is decoded only if an error is noted in incoming data by said CRC checking scheme.

40. The method of claim 27, wherein said receive module dynamically adjusts bandwidth utilization as circumstances change, or as new applications are deployed that alter a bandwidth profile.

41. The method of claim 29, wherein said receive module responds with a downstream response message to acknowledge receipt of one or more request messages, and informs a corresponding one or more set top box how and when to transmit information.

42. The method of claim 41, wherein said receive module response message contains fields indicating any of set top box ID, upstream channel assignment to be used for data, amount of information to be transmitted, and a delay period before transmitting.

43. The method of claim 27, wherein concatenation of multiple upstream transmissions in periods of high demand reduces the impact of system latency in wasting upstream bandwidth, and avoids collisions.

44. The method of claim 29, further comprising the step of:
providing an acknowledge message.

45. The method of claim 27, wherein successive or simultaneous requests from different set top boxes may be assigned to different upstream channels, wherein set top box responses may be overlapped using frequency division multiplexing.

46. The method of claim 41, further comprising the step of:
addressing multiple set top boxes with each response message.

47. The method of claim 41, wherein a single response message may contain channel assignments for multiple set top boxes when there is more than one pending request.

48. The method of claim 41, wherein sequential responses from different set top boxes on a same channel may be scheduled with a single message when a number of pending requests is greater than a number of channels.

49. The method of claim 48, wherein a second set top box to respond on a same channel is instructed to wait for a period that equals a sum of a transmission time for a first message, plus a worst case latency for upstream transmission, which is a sum of a response latency of said second set top box and any system delay due to a physical location of a subscriber;
wherein location delay may optionally be any of a system worst case, a node worst case, or it may be measured and maintained in a local database on an individual subscriber basis;
and wherein units for said wait period may optionally be in any of packet times if a size of packets is fixed, in seconds, or in system clock ticks.

50. The method of claim 41, wherein having received a response message, said at least one set top box tunes to a designated channel, waits for a specified delay to elapse;
wherein said at least one set top box then transmits its negotiated amount of data;
wherein said at least one set top box then retunes to said request channel;
wherein a timer is started which represents maximum latency that might be encountered;
wherein said at least one set top box waits for its action message;
wherein if no action message is received before said timer elapses, said at least one set top box sends a new request message with a new request ID; and
wherein if an action message is received, said at least one set top box takes an indicated action.

51. An interactive voice control method for an interactive digital television system, comprising the steps of:
providing a receive module, said receive module comprising a multichannel receive card comprising a plurality of channels for communication with at least one set top box, wherein at least one of said channels is a shared request channel;
providing at least one set top box; and
implementing a data transmission scheme between said at least one set top box and said receive module.

52. The method of claim 51, further comprising the step of:
increasing bandwidth latency in said data transmission scheme to improve interactive digital television.

53. A multicarrier communications system, comprising:
a central communications nexus;
a user terminal;
a data transmission scheme for effecting between said communications user terminal and said central communications nexus; and
a protocol for increasing bandwidth assignment latency in said data transmission scheme to improve channel utilization in said communications system.

54. The system of claim 53, wherein said system comprises a cable television system.

55. The system of claim 54, wherein said system comprises an interactive digital television system.

56. The system of claim 53, further comprising:
a multichannel receive module comprising a plurality of channels for communication with at least one user terminal, wherein at least one of said channels is a shared request channel.

57. The system of claim 56, wherein said at least one user terminal uses said shared request channel to send a request message to said receive module when said at least one user terminal has data available, said at least one user terminal identifying itself and stating an amount of data that it has to send.

58. The system of claim 53, said means for increasing bandwidth assignment latency comprising:
means for maximizing sequential transmit time for each transmitter.

59. The system of claim 53, said means for increasing bandwidth assignment latency comprising:
means for concatenating all calls from a single user terminal into a contiguous transmission.

60. The system of claim 56, wherein upstream transmissions on each channel are time multiplexed, and a period of each upstream transmission is completely variable, depending on the needs of each of said at least one user terminal and a total amount of traffic at that time.

61. The system of claim 53, further comprising:
a voice link for capturing a user's utterance.

62. The system of claim 61,wherein said voice link notifies an application on said at least one user terminal, which generates a request message;
said receive module processing said request message from said at least one user terminal and sending a response message via an out of band transmitter telling said at least one user terminal where to send its data.

63. The system of claim 62, wherein said at least one user terminal sends voice link data in data message at a specified time.

64. The system of claim 63, wherein said receive module sends said voice link data to a system engine, wherein said system engine recognizes a user's request and formulates an appropriate action.

65. The system of claim 64, wherein an action message is transmitted to said at least one user terminal via said receive module and said out of band transmitter.

66. The system of claim 65, wherein said at least one user terminal receives said action message and implements actions indicated therein, which actions may be any of local to said at least one user terminal, performed in conjunction with a system engine channel, or performed in conjunction with other equipment.

67. The system of claim 57, said request message comprising:
a CRC checking scheme.

68. The system of claim 67, said request message comprising:
an error correcting code (ECC) that permits data errors to be corrected, rather than forcing a retransmission of said message;
wherein said ECC is decoded only if an error is noted in incoming data by said CRC checking scheme.

69. The system of claim 53, wherein said receive module comprises:
means for dynamically adjusting bandwidth utilization as circumstances change, or as new applications are deployed that alter a bandwidth profile.

70. The system of claim 57, wherein said receive module responds with a downstream response message to acknowledge receipt of one or more request messages, and informs a corresponding one or more user terminal how and when to transmit information.

71. The system of claim 70, wherein said receive module response message contains fields indicating any of user terminal ID, upstream channel assignment to be used for data, amount of information to be transmitted, and a delay period before transmitting.

72. The system of claim 53, wherein concatenation of multiple upstream transmissions in periods of high demand reduces the impact of system latency in wasting upstream bandwidth, and avoids collisions.

73. The system of claim 57, further comprising:
an acknowledge message.

74. The system of claim 53, wherein successive or simultaneous requests from different user terminals may be assigned to different upstream channels, wherein user terminal responses may be overlapped using frequency division multiplexing.

75. The system of claim 70, further comprising:
means for addressing multiple user terminals with each response message.

76. The system of claim 70, wherein a single response message may contain channel assignments for multiple user terminals when there is more than one pending request.

77. The system of claim 70, wherein sequential responses from different user terminals on a same channel may be scheduled with a single message when a number of pending requests is greater than a number of channels.

78. The system of claim 77, wherein a second user terminal to respond on a same channel is instructed to wait for a period that equals a sum of a transmission time for a first message, plus a worst case latency for upstream transmission, which is a sum of a response latency of said second user terminal and any system delay due to a physical location of a subscriber;
wherein location delay may optionally be any of a system worst case, a node worst case, or it may be measured and maintained in a local database on an individual subscriber basis;
and wherein units for said wait period may optionally be in any of packet times if a size of packets is fixed, in seconds, or in system clock ticks.

79. The system of claim 70, wherein having received a response message, said at least one user terminal tunes to a designated channel, waits for a specified delay to elapse;
wherein said at least one user terminal then transmits its negotiated amount of data;
wherein said at least one user terminal then returns to said request channel;
wherein a timer is started which represents maximum latency that might be encountered;
wherein said at least one user terminal waits for its action message;
wherein if no action message is received before said timer elapses, said at least one user terminal sends a new request message with a new request ID; and
wherein if an action message is received, said at least one user terminal takes an indicated action.

80. A multicarrier communications system including a plurality of user terminals said system, comprising:
a multichannel receive module comprising a plurality of channels for communication with at least one user terminal, wherein at least one of said channels is a shared request channel;
a data transmission scheme for effective communications between said user terminals and said receive module; and
a protocol for increasing bandwidth assignment latency in said data transmission scheme to improve channel utilization in said communications system.

81. A multicarrier communications method, comprising the steps of:
providing a receive module;
providing at least one user terminal;
implementing a data transmission scheme between said at least one user terminal and said receive module; and
increasing bandwidth assignment latency in said data transmission scheme to improve channel utilization in said communications method.

82. The method of claim 81, the step of providing said receive module further comprising the step of:
providing a multichannel receive card comprising a plurality of channels for communication with at least one user terminal, wherein at least one of said channels is a shared request channel.

83. The method of claim 82, wherein said at least one user terminal uses said shared request channel to send a request message to said receive card when said at least one user terminal has data available, said at least one user terminal identifying itself and stating an amount of data that it has to send.

84. The method of claim 81, wherein increasing bandwidth assignment latency comprises the step of:
making upstream data transmission time take as long as is possible.

85. The method of claim 84, wherein upstream transmissions on each channel are time multiplexed, and a period of each upstream transmission is completely variable, depending on the needs of each of said at least one user terminal and a total amount of traffic at that time.

86. The method of claim 81, further comprising the step of:
providing a voice link for capturing a user's utterance.

87. The method of claim 86, wherein said voice link notifies an application on said at least one user terminal, which generates a request message;
said receive module processing said request message from said at least one user terminal and sending a response message via an out of band transmitter telling said at least one user terminal where to send its data.

88. The method of claim 87, wherein said at least one user terminal sends voice link data in data message at a specified time.

89. The method of claim 88, wherein said receive module sends said voice link data to a system engine, wherein said system engine recognizes a user's request and formulates an appropriate action.

90. The method of claim 89, wherein an action message is transmitted to said at least one user terminal via said receive module and said out of band transmitter.

91. The method of claim 90, wherein said at least one set top box receives said action message and implements actions indicated therein, which actions may be any of local to said at least one set top box, performed in conjunction with a system engine channel, or performed in conjunction with other equipment.

92. The method of claim 83, said request message comprising:
a CRC checking scheme.

93. The method of claim 92, said request message comprising:
an error correcting code (ECC) that permits data errors to be corrected, rather than forcing a retransmission of said message;
wherein said ECC is decoded only if an error is noted in incoming data by said CRC checking scheme.

94. The method of claim 81, wherein said receive module dynamically adjusts bandwidth utilization as circumstances change, or as new applications are deployed that alter a bandwidth profile.

95. The method of claim 83, wherein said receive module responds with a downstream response message to acknowledge receipt of one or more request messages, and informs a corresponding one or more user terminal how and when to transmit information.

96. The method of claim 95, wherein said receive module response message contains fields indicating any of set top box ID, upstream channel assignment to be used for data, amount of information to be transmitted, and a delay period before transmitting.

97. The method of claim 81, wherein concatenation of multiple upstream transmissions in periods of high demand reduces the impact of system latency in wasting upstream bandwidth.

98. The method of claim 83, further comprising the step of:
providing an acknowledge message.

99. The method of claim 81, wherein successive or simultaneous requests from different user terminals may be assigned to different upstream channels, wherein user terminal responses may be overlapped using frequency division multiplexing.

100. The method of claim 95, further comprising the step of:
addressing multiple user terminals with each response message.

101. The method of claim 95, wherein a single response message may contain channel assignments for multiple user terminals when there is more than one pending request.

102. The method of claim 95, wherein sequential responses from different user terminals on a same channel may be scheduled with a single message when a number of pending requests is greater than a number of channels.

103. The method of claim 102, wherein a second user terminal to respond on a same channel is instructed to wait for a period that equals a sum of a transmission time for a first message, plus a worst case latency for upstream transmission, which is a sum of a response latency of said second set top box and any system delay due to a physical location of a subscriber;
wherein location delay may optionally be any of a system worst case, a node worst case, or it may be measured and maintained in a local database on an individual subscriber basis;
and wherein units for said wait period may optionally be in any of packet times if a size of packets is fixed, in seconds, or in system clock ticks.

104. The method of claim 95, wherein having received a response message, said user terminal tunes to a designated channel, waits for a specified delay to elapse;
wherein said user terminal then transmits its negotiated amount of data;
wherein said user terminal then retunes to said request channel;
wherein a timer is started which represents maximum latency that might be encountered;
wherein said user terminal waits for its action message;
wherein if no action message is received before said timer elapses, said user terminal sends a new request message with a new request ID; and
wherein if an action message is received, said user terminal takes an indicated action.

105. In a multicarrier communications system including a plurality of user terminals, a method comprising the steps of:
providing a multichannel receive module comprising a plurality of channels for communication with said user terminals, wherein at least one of said channels is a shared request channel;
implementing a data transmission scheme between said user terminals and said receive module; and
increasing bandwidth assignment latency in said data transmission scheme to improve channel utilization in said communications system.
